(19) United States
(12) Patent Application Publication
(10) Pub. No.: US 2012/0100062 A1
(43) Pub. Date: Apr. 26, 2012

(54) COMBINED PLANT

(76) Inventors: Norihiko Nakamura, Mishima-shi (JP); Shigeki Sugiura, Suntou-gun (JP); Shusei Obata, Nagoya-shi (JP); Shinichi Takeshima, Numazu-shi (JP); Haruyuki Nakanishi, Susono-shi (JP); Yosuke Iida, Susono-shi (JP); Akinori Sato, Susono-shi (JP)

(21) Appl. No.: 13/318,223

(22) PCT Filed: Apr. 28, 2010
(86) PCT No.: PCT/JP2010/057918

§ 371 Date: Dec. 30, 2011

(30) Foreign Application Priority Data
May 5, 2009 (CN) 200910149706.3

(51) Int. Cl. C01C 1/04; B01J 19/12; C01B 3/06

(52) U.S. Cl. 423/359; 252/375; 422/148

(57) ABSTRACT

A combined plant is provided. The combined plant of continuously supplying hydrogen and nitrogen to an ammonia synthesis facility that continuously synthesizes ammonia from hydrogen and nitrogen, the combined plant including: a hydrogen production facility for acquiring solar energy and producing hydrogen by utilizing a part of the acquired solar energy; a nitrogen production facility for producing nitrogen from air and supplying the nitrogen to the ammonia synthesis facility; and a hydrogen storage facility for storing the hydrogen produced by the hydrogen production facility and supplying the produced hydrogen to the ammonia synthesis facility.

### TECHNICAL FIELD

The present invention relates to a combined plant.

### BACKGROUND ART

The recent global warming grows into an increasingly serious problem. The main cause thereof is considered to be carbon dioxide (CO₂) or the like released into the atmosphere from fossil fuels, such as petroleum and natural gas, which have been used in large amounts as an energy source during the 20th century.

On the other hand, with the increase in energy demand, the exhaustion of fossil fuels heretofore considered inexhaustible becomes a reality, and the price is rising at a far higher rate than not expected. In the near future, it will become more difficult for humankind to rely on fossil fuels.

As an alternative energy to fossil fuel, such as petroleum and natural gas, studies are being made at present on coal energy, biomass energy, nuclear energy and solar energy.

However, in the case of coal energy as an alternative energy, a large amount of carbon dioxide is released by the combustion of coal and this is thought to become a problem. In order to solve this problem, collecting carbon dioxide at the combustion and storing it in underground, and numerous researches have been proposed, but long-term stable storage is not certain and also, the place suitable for storage is unevenly distributed. Furthermore, it costs a lot to collect and transfer carbon dioxide and inject into the ground will become a problem. In addition, the possibility that the combustion of coal will raise an environmental issue due to generation of sulfur oxide (Soₓ), smoke and the like will also result in a problem.

Biomass energy as an alternative energy, in particular, biofuel such as ethanol, is recently attracting a great deal of attention, However, a large amount of energy is necessary for the production and concentration of ethanol from plants, and this is sometimes disadvantageous in view of energy efficiency. Furthermore, in the case of utilizing corn, soybean, sugarcane or the like as the raw material for biofuel, since these are also used as food and animal feed, escalation in the price of food and feed is incurred. Accordingly, biomass energy cannot be considered a substantial energy source, except for in areas such as Brazil.

Utilization of nuclear energy as an alternative energy is not expected to make great and worldwide progress, because no satisfactory solution has been found for treating radioactive waste from nuclear power plants and there are many opposing opinions based on the fear of nuclear proliferation. Instead, nuclear energy as an alternative energy may decrease as nuclear reactors become decommissioned.

As described above, coal energy, biomass energy and nuclear energy will not succeed in solving the problems of sustainability and carbon dioxide generation leading to global warming. Consequently, solar energy is an ideal energy source.

### SUMMARY OF INVENTION

Solar energy is very potent as an alternative energy, but its utilization in the social activity faces problems that (1) the energy density of solar energy is low and (2) the storage and transfer of solar energy are difficult. However, when the problem of (2) regarding the storage and transfer of solar energy is solved, a vast area such as desert can be ensured, and usability of a vast area eliminates the problem of low energy density.

In order to solve the above-described problem, it is necessary to convert solar energy into chemical energy that is easy to store and transfer. Although various substances may be possible, considering handleability, safety, utilization of existing infrastructures and application as energy, ammonia seems to be most suitable. The production method of ammonia includes: in a hydrogen production facility, acquiring solar energy and producing hydrogen from water by utilizing a part of the acquired solar energy; in a nitrogen production facility, producing nitrogen from air; in a hydrogen storage facility, storing the produced hydrogen; and in an ammonia synthesis facility, continuously synthesizing ammonia from the produced hydrogen and the produced nitrogen.

### BRIEF DESCRIPTION OF DRAWINGS

The present invention is described below by referring to the attached drawings.

FIG. 1 is a view illustrating one example of the ammonia production plant.

FIG. 2 is a view illustrating one example of the parabolic dish-type light collector.

FIG. 3 is a view illustrating one example of the solar tower-type light collector.

FIG. 4 is a view illustrating one example of the parabolic trough-type light collector.

FIG. 5 is a view illustrating one example of the hydrogen production facility.

FIG. 6 is a view illustrating one example of the hydrogen storage facility.

FIG. 7 is a view illustrating another example of the hydrogen storage facility.

FIG. 8 is a view illustrating one example of the nitrogen production facility.

FIG. 9 is a view illustrating one example of the nitrogen production facility for producing nitrogen by cryogenic separation.

FIG. 10 is a view illustrating one example of the ammonia synthesis facility.

FIG. 11 is a view illustrating another example of the ammonia synthesis facility.

FIG. 12 is a view illustrating one example of the collected light amount.

FIG. 13 is a view illustrating one example of the control apparatus for performing computation of the ammonia production amount and control of the ammonia production amount.

FIG. 14 is a view illustrating the flow of processing to perform computation of the ammonia production amount and control of the ammonia production amount.

FIG. 15 is a view illustrating one example of the process flow for illustrating the material balance of the ammonia plant.

FIG. 16 is a view illustrating the material balance in the process flow shown in FIG. 15.

FIG. 17 is a view illustrating one example of the combined plant for supplying a synthesis gas to an ammonia synthesis facility 400.

### DESCRIPTION OF EMBODIMENTS

Regarding the storage and transfer of solar energy, ammonia (NH₃) is considered a liquid fuel that can be produced from water, air and solar energy and is easy to store and transfer.

Global ammonia production at present is about 150 million tons per year, and a large amount of ammonia is mainly used for fertilizer. Also from such actual use in a large amount on the market, ammonia is believed to have sufficiently high social receptivity.

Ammonia has physical characteristics close to those of LPG and is easily liquefied under about 8 atm at ordinary temperature, and the storage and transfer thereof have satisfactory results and are not particularly problematic. Also, ammonia is defined as a nonflammable substance which has small ignition ability, low combustion speed even when catching fire, and a narrow combustion range, and therefore, its handling is considered to have no particular problem.

The energy density of ammonia is about half that of gasoline and almost equal to that of methanol but in terms of the calorific value with a theoretical mixing ratio, ammonia is comparable to gasoline and satisfactorily applicable as a fuel also to a mobile body. Furthermore, ammonia can be supplied to a remotely-located thermal power plant by a tanker or the like and burned instead of natural gas or coal and in this case, the efficiency is theoretically considered to surpass natural gas and coal.

In the combustion of ammonia, a combustion reaction represented by the following formula 1 can be performed.

2NH₃+3/20₂→N₂+3H₂O+(calorific value) (formula 1)

That is, carbon dioxide is not produced in the combustion of ammonia, and there arises no problem of global warming:

The embodiments are described below by referring to the drawings.

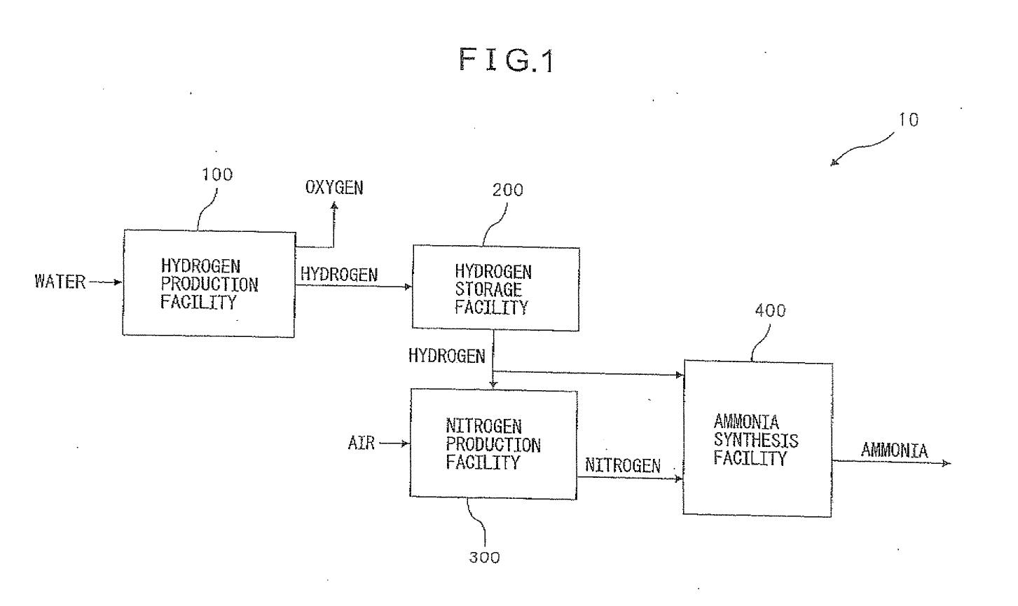

One example of the ammonia production plant for synthesizing ammonia by using solar energy is described by referring to FIG. 1. As shown in FIG. 1, the ammonia production plant 10 has a hydrogen production facility 100, a hydrogen storage facility 200, a nitrogen production facility 300 and an ammonia synthesis facility 400.

The hydrogen production facility 100 is a facility for acquiring solar energy and producing hydrogen from water by utilizing the acquired solar energy. In the hydrogen production facility 100, solar energy is used as the energy source for the hydrogen production and therefore, hydrogen is produced during daytime in which solar energy is radiated, and is stopped during the nighttime when solar energy is not radiated.

The nitrogen production facility 300 is a facility for producing nitrogen that is a part of the synthesis gas of the ammonia synthesis facility 400, from air. In the nitrogen production facility 300, solar energy is not used directly and as described later, nitrogen is produced utilizing external electric power or hydrogen combustion, so that a continuous operation can be performed day and night by supplying an external power source or hydrogen.

The ammonia synthesis facility 400 is a facility for synthesizing ammonia from hydrogen and nitrogen. In the ammonia synthesis facility 400, ammonia is continuously synthesized day and night.

The hydrogen storage facility 200 is a facility for storing hydrogen produced in the hydrogen production facility 100 and continuously supplying hydrogen to the ammonia synthesis facility 400 and depending on the case, to the-nitrogen production facility 300.

In this way, in the hydrogen production facility 100, hydrogen production is stopped during nighttime, but in the ammonia synthesis facility 400, ammonia is continuously synthesized day and night. If running of the ammonia synthesis facility 400 is made intermittent in synchronization with running of the hydrogen production facility 100, an energy loss is produced due to the startup process and shutdown process of the ammonia synthesis facility 400. Therefore, the hydrogen storage facility 200 stores at least a part of hydrogen produced in the hydrogen production facility 100 during the daytime and supplies the stored hydrogen to the ammonia synthesis facility 400 even in the nighttime, whereby the ammonia production plant 10 enables the ammonia synthesis facility 400 to continuously synthesize ammonia. By the continuous running of the ammonia synthesis facility, the energy loss produced due to intermittent running of the ammonia synthesis facility, such as daytime working with stopping during nighttime, can be reduced.

Respective facilities included in the ammonia production plant 10 are described sequentially in detail below.

### <Hydrogen Production Facility 100>

The hydrogen production facility 100 is a facility for acquiring solar energy and producing hydrogen by utilizing a part of the acquired solar energy.

### <Hydrogen Production Facility 100 (Acquisition of Solar Energy>

The method for acquiring solar energy includes, in addition to a method of simply receiving solar light, a method of collecting light so as to increase the energy density. For example, the following light collectors (1) to (3) can be utilized.

### (A1) Parabolic Dish Type

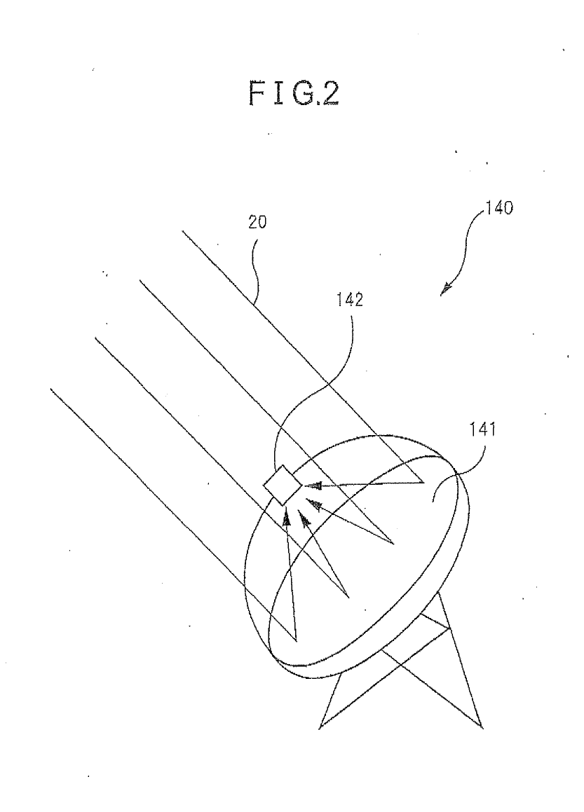

FIG. 2 is a view illustrating one example of the parabolic dish-type light collector. The parabolic dish-type light collector shown in FIG. 2 has a dish reflector part 141 for collecting light by reflecting sunlight 20 and a light-receiving part 142 for receiving the collected light, and solar thermal energy is acquired in the light-receiving part 142. The solar thermal energy obtained in the light-receiving part 142 may be allowed to directly drive a Stirling engine because of its high temperature or may be transferred to a required portion by optionally utilizing a heat medium such as molten alkali metal (e.g., molten sodium metal), molten salt, oil and water vapor. The parabolic dish-type light collector is suitable for a relatively small facility and is preferably used in a solar thermal energy range of approximately from 10 kW to several hundreds of kw. In general, the parabolic dish-type light collector has high light-collecting power, and a high-temperature heat source of 2,000° C. or more can be obtained thereby, but the cost is higher than the later-described types of light collectors.

### (A2) Solar Tower Type

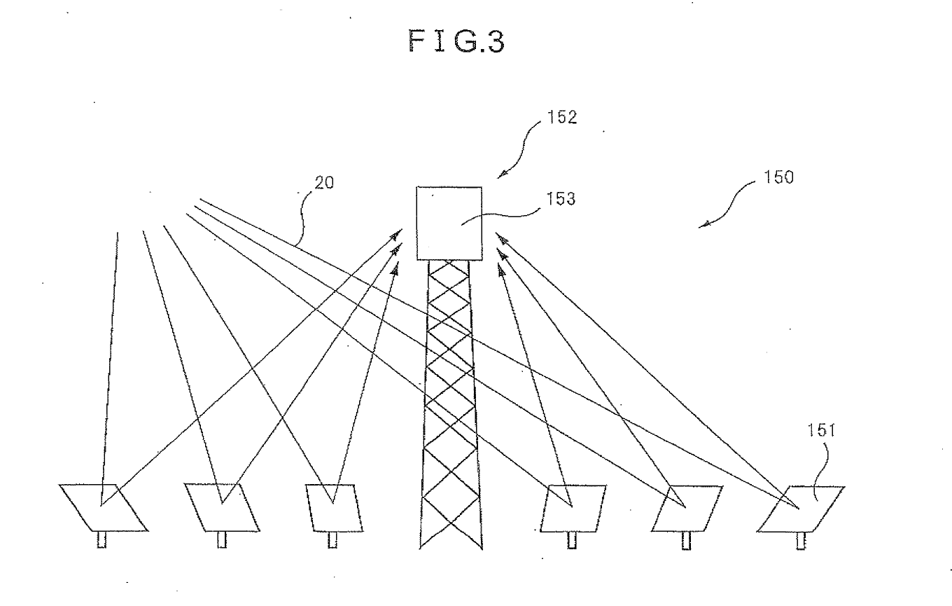

FIG. 3 is a view illustrating one example of the solar tower-type light collector. The solar tower-type light collector 150 shown in FIG. 3 has a plurality of reflector parts 151 for collecting light by reflecting sunlight 20 and a light-receiving part 153 for receiving the collected light, and solar thermal energy is acquired in the light-receiving part 153. The light-receiving part 153 is disposed at the top of a light-receiving tower 152. The reflector parts 151 are controlled to face the light-receiving part 153 along the movement of sun. The solar thermal energy obtained in the light-receiving part 153 can be transferred to a required portion by optionally utilizing a heat medium. The solar tower-type light collector is suitable for a large plant of 10 MW to several hundreds of MW. Generally, the solar tower-type light collector has large light-collecting power, and a high-temperature heat source of 1,000° C. or more can be obtained, but the construction cost of the tower is high.

### (A3) Parabolic Trough Type

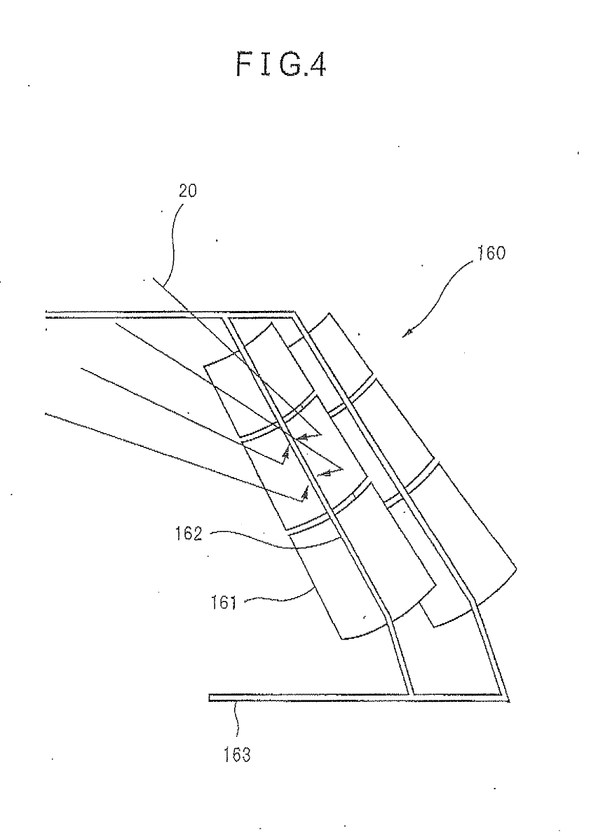

FIG. 4 is a view illustrating one example of the parabolic trough-type light collector. The parabolic trough-type light collector shown in FIG. 4 has a trough reflector part 161 for collecting light by reflecting sunlight 20 and a light-receiving part 162 for receiving the collected light, and solar thermal energy is acquired in the light-receiving part 162. The solar thermal energy obtained in the light-receiving part 162 can be transferred to a required portion by optionally flowing a heat medium through a heat medium flow path 163. The parabolic trough-type light collector enjoys a simple structure and a low cost and is suitable for a large facility of generally several hundreds of MW, but the light-collecting power is low and the heat source obtained is a low-temperature heat source of 400 to 500° C.

As described above, every light collector has its own characteristics. Accordingly, in the hydrogen production facility 100, any one of these light collectors or a combination thereof can be utilized. Specifically, the solar thermal energy for a high-temperature heat source can be obtained by a light collector having large light-collecting power (for example, a parabolic dish-type light collector and/or a solar tower-type light collector) and at the same time, the solar thermal energy, for example, for a low-temperature heat source or for power energy can be obtained by a light collector having small light-collecting power (for example, a parabolic trough collector).

For instance, the solar thermal energy obtained by a light collector having large light-collecting power can be set to be ½ or less, for example, from ⅓ to ½, of the total solar thermal energy obtained by a light collector having large light-collecting power and a light collector having small light-collecting power. In view of the cost of the entire light collection facility, it is sometimes preferred that the ratio of a light collector having large light-collecting power, which generally costs high, is limited in this way.

### <Hydrogen Production Facility 100 (Hydrogen Production Method)>

Regarding the method for producing hydrogen from water by utilizing a part of the acquired solar energy, a plurality of methods can be used. Specifically, for example, the following water decomposition methods (B1) to (B6) may be used. The methods (B1) to (B4) are focused on lowering of the reaction temperature necessary for water decomposition reaction, and the method (B5) is focused on elevation of utilization factor of the light energy.

### (B1) Direct Pyrolysis Method

This is a most basic method, and water is directly decomposed into hydrogen and oxygen under a high temperature by the reaction represented by the following formula 2.

H₂O→H₂+1/20₂(2000° C. or more) (formula 2)

This reaction originally requires a temperature of thousands of ° C. but can be attained at a temperature of around 2,000° C. by utilizing a catalyst.

### (B2) Metal Oxidation/Reduction Method

In order to lower the high temperature required in (B1), there is a method of decomposing water with the intervention of a third substance. A typical example thereof is a method involving intervention of zinc and in this case, the reaction formula is as follows.

Zn+H₂O→ZnO+H₂(about 400° C.) (formula 3)

ZNO→2n+1/20₂(about 1,700° C.) (formula 4)

(Total reaction)H₂O→H₂+1/20₂

This method requires two kinds of heat sources, i.e., a high-temperature heat source (about 1,700° C.) and a low-temperature heat source (400° C.). (B3) I-S (Iodine-Sulfur) Method

As a method for lowering the reaction temperature more than the reaction temperature in the method (B2), an I-S cycle method is known. In the I-S method, hydroiodic acid or sulfuric acid obtained by reacting raw material water and compounds of iodine (I) and sulfur (S) is thermally decomposed by utilizing heat up to about 850° C., whereby hydrogen and oxygen are produced. The reactions are as follows.

H₂SO₄→H₂O+SO₂+1/20₂(about 850° C.). (formula 5)

2H₂O+SO₂+I₂→H₂SO₄+2HI(about 130° C.) (formula 6)

2HI→H₂+I₂(about 400° C.) (formula 7)

Total reaction: H₂O→H₂+1/20₂

This method requires two kinds of heat sources, i.e., a high-temperature heat source (850° C.) and a low-temperature heat source (400° C.).

### (B4) UT-3 Cycle Method

As a method for lowering the reaction temperature more than the reaction temperature in the method (B2), a UT-3 cycle method is known, The reactions are as follows.

CaBr₂(s)+H₂O(g)→CaO(s)+2HBr(g)(700 to 750° C.) (formula 8)

CaO(s)+Br₂(g)→CaBr₂(s)+1/20₂(g)(500 to 600° C.) (formula 9)

Fe₃O₄(s)+8HBr(g)→FeBr₂(g)+4H₂O(g)+Br₂(g)(200 to 300° C.) (formula 10)

3Fe₃O₄(s)+4H₂O(g)→Fe₃O₄(s)+6HBr(g)+H₂(g)(550 to 600° C.) (formula 11)

When four reactions represented by formulae 8 to 11 are added, a reaction of causing water to decompose into hydrogen and oxygen remains, and other compounds are circulated in the cycle. Each reaction proceeds at the temperature shown in formulae 8 to 11 and therefore, in order to promote the cycle, a heat energy up to 750° C. may be sufficient.

As described above, in all of the reactions of (B1) to (B4) for producing hydrogen from water by utilizing heat, a heat source at a relatively high temperature is required in at least a part of the reaction.

The heat source at a relative high temperature can be provided by directly utilizing the acquired solar thermal energy as a heat source, and in this case, at least a part of the required solar thermal energy can be obtained by a light collector having large light-collecting power, for example, a parabolic dish-type light collector and/or a solar tower-type light collector.

### (B5) Hydrolysis by Photocatalyst

This is a method for electrochemically decomposing water by using light energy instead of heat energy. When sunlight is applied to a photocatalyst in contact with water at near room temperature, water decomposes to generate hydrogen and oxygen. A typical photocatalyst is titanium oxide. However, in the case of titanium oxide, only light in the ultraviolet region in sunlight contributes to this reaction, and visible light and near infrared light occupying the majority of sunlight cannot be utilized, resulting in extremely low efficiency. To solve this problem, studies are being made on various photocatalysts, for example, a photocatalyst enabled to utilize light even in the visible light region by mixing impurities such as nitrogen atom or sulfur atom. Also, elevating efficiency of water decomposition by combining a material capable of generating electromotive power upon receipt of light, such as material that becomes a dye or a solar cell material, with a photocatalyst is being aggressively studied. On the other hand, the photocatalyst does not require a high-temperature heat source and probably leads to a very low plant cost per area and therefore, its use has potential for becoming a mainstream technique when the site area has room.

### (B6) Electrolysis Method of Water

Hydrogen can be produced by electrolyzing water. Examples of the electrolysis method of water include an alkali water electrolysis method and a solid polymer electrolyte water electrolysis method. In the alkali water electrolysis method, for example, an aqueous KOH solution is used. In the solid polymer electrolyte water electrolysis method, for example, a fluororesin-based ion exchange membrane is used for the electrolyte.

### <Hydrogen Production Facility (Description of Facility)>

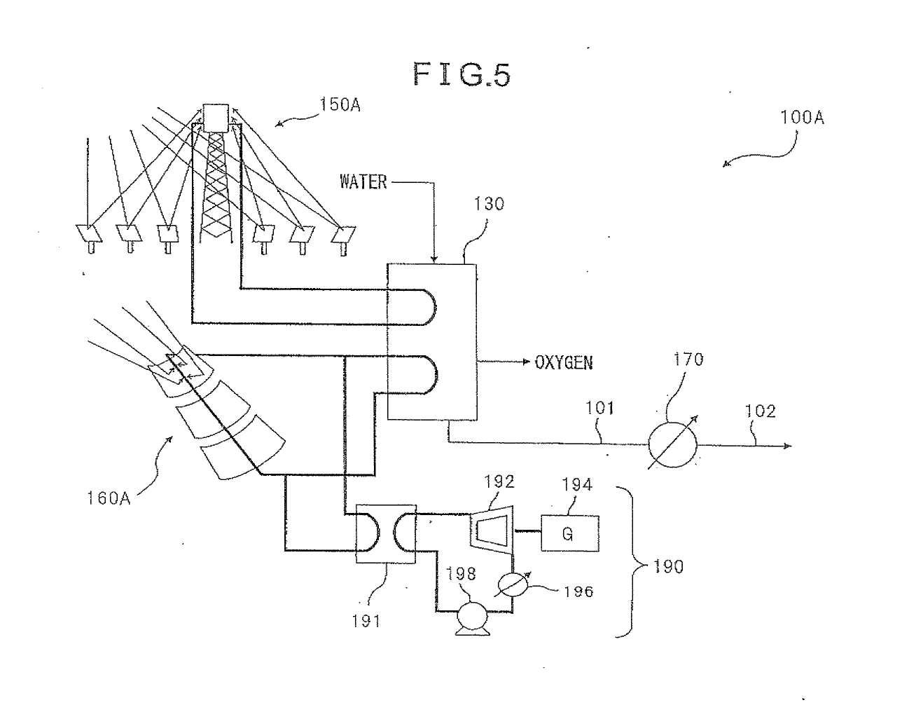

A hydrogen production facility 100A shown in FIG. 5, which is one example of the hydrogen production facility 100, is described below.

The hydrogen production facility 100A has a reaction apparatus 130, light collecting facilities 150A and 160A, and a heat exchanger 170. The reaction apparatus 130 is an apparatus for producing hydrogen from water by any of the methods (B1) to (B4) and (B6).

Although not shown in the Figure, the reaction apparatus 130 may be an apparatus for producing hydrogen from water by the method (B5) by directly receiving sunlight. Also, the reaction apparatus 130 has a plurality of devices having functions for implementing operations such as distillation, decomposition, recovery, mixing, pressurization, heat exchange and the like so as to perform any of (B1) to (B5). The reaction apparatus 130 may have a function of removing substances associated with the hydrogen production reaction. For example, in the case of the I-S method, hydrogen is sometimes accompanied by hydrogen iodide (HI and iodide (I₂) due to reaction of formula 7. Furthermore, in the case of the UT-3 method, hydrogen is sometimes accompanied by hydrogen bromide (HBr) due to reaction of formula (11). In such a case, the associated gas needs to be removed by purification before coming into contact with an ammonia synthesis catalyst, and the purification and removal may be performed in the reaction apparatus 130.

The light collection facility 150A is a light collection facility having high light-collecting power and corresponds, for example, to a solar tower-type collector 150 described by referring to FIG. 3. The solar thermal energy collected in the light collection facility 150A may be utilized, for example, as a high-temperature heat source for realizing the reaction temperature of 750° C. or more set forth in (B2) to (B4). The light collection facility 160A is a light collection facility having low light-collecting power and corresponds, for example, to a parabolic trough-type collector 160 described by referring FIG. 4. The light collection facility 160A may be utilized, for example, as a high-temperature heat source for realizing the low reaction temperature of less than 750° C. set forth in (B2) to (B4). In terms of the cost of the entire light collection facility, it is sometimes preferred to perform acquisition of solar thermal energy in this way by a light collector having small light-collecting power, for example, a parabolic trough-type collector. Also, in FIG. 5, two kinds of light collection facilities are shown, but all reaction temperatures during hydrogen production reaction may be realized by using only the light collection facility 150A.

As described above, the hydrogen production facility 100A produces hydrogen and oxygen from water by utilizing a part of the acquired solar energy. The oxygen may be utilized in different applications or may be released into the air. The produced hydrogen is charged into a line 101 from the reaction apparatus 130. Hydrogen in the line 101 is cooled by a heat exchanger 170 and charged into a line 102. In this cooling treatment, heat and/or power recovery with steam may be performed, or the hydrogen may be cooled with cooling water (CW) to a predetermine temperature for the compressor (described later) of the hydrogen storage facility 200. The hydrogen in the line 102 is transferred under pressure to the hydrogen storage facility 200.

Incidentally, as shown in FIG. 5, the hydrogen production facility 100A may have an power generation unit 190. The power generation unit 190 has a heat exchanger 191, a steam turbine 192, a power generator 194, a condenser 196 and a pump 198. The heat exchanger 191 generates steam by heat-exchanging of a high-temperature heat medium with water. The steam turbine 192 is a turbine that is rotated by steam discharged from the heat exchanger 191. The power generator 194 is connected to the steam turbine 192 and recovers the power from the rotating rotor to thereby perform power generation. The condenser 196 cools the steam discharged from the steam turbine 192 and returns it to water, and the water is again fed into the heat exchanger 191 by the pump 198. Incidentally, in the example above, steam is produced using a heat exchanger 191, but instead of heat-exchanging with a heat medium, a configuration of directly producing steam in the light collector indicated by 150 to 160 may be employed.

In the case of using the electrolysis method of water of (B6), the reaction apparatus 130 functions as an apparatus for performing electrolysis of water. The electricity used for electrolysis of water is supplied to the reaction apparatus 130 from the power generator 194.

### <Hydrogen Storage Facility>

The hydrogen storage facility 200 is a facility for storing hydrogen produced in the hydrogen production facility 100 and supplying hydrogen to the nitrogen production facility 300 and the ammonia synthesis facility 400. At least a part of hydrogen produced in the hydrogen. production facility 100 during daytime is stored, and the stored hydrogen is supplied to the nitrogen production facility 300 and the ammonia synthesis facility 400 even during nighttime, whereby the hydrogen storage facility 200 enables continuous running of the nitrogen production facility and the ammonia synthesis facility 400.

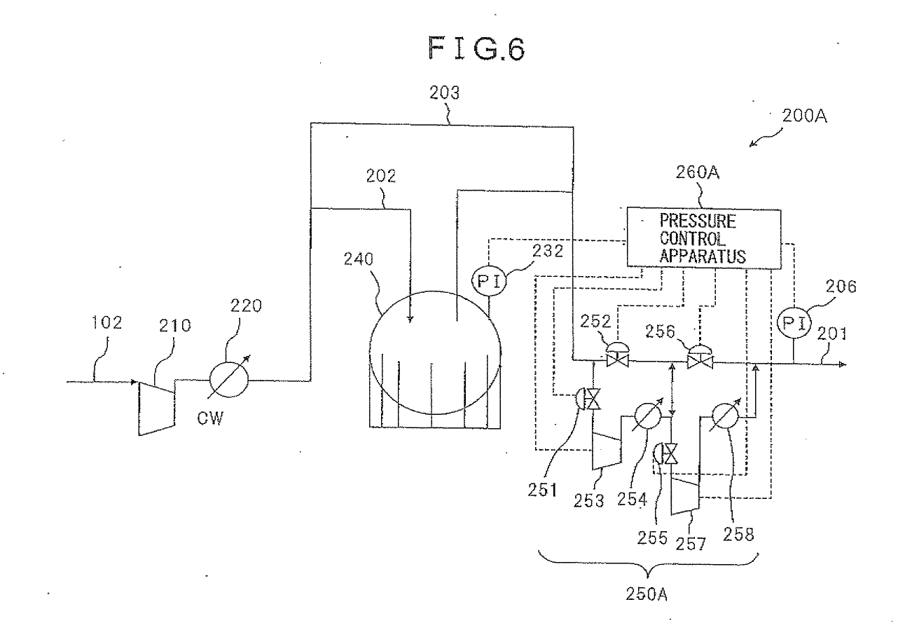

FIG. 6 shows a hydrogen storage facility 200A that is one example of the hydrogen storage facility 200. The hydrogen storage facility 200A has a compressor 210, a heat exchanger 220, a hydrogen tank 240, a compression unit 250A and a pressure control apparatus 260A.

The line 102 connected to the hydrogen production facility 100 is connected to the inlet of the compressor 210.

The pressure at the outlet of the compressor 210 may be determined according to the supply pressure to a combustor (described later) of a gas turbine in the nitrogen production facility 300 and/or the synthesis gas supply pressure to a reaction vessel (described later) in the ammonia synthesis facility 400. The pressure on the inlet side of the hydrogen tank 240 is raised in this way, whereby the energy for pressurization immediately before the gas turbine combustor in the nitrogen production facility 300 or pressurization immediately before the reaction vessel in the ammonia synthesis facility 400 can be reduced and at the same time, by a rise in the density of gas stored in the hydrogen-tank 240, the volume of the hydrogen tank 240 can be made small.

The heat exchanger 220 cools hydrogen heated by pressurization of the compressor 210.

The hydrogen tank 240 stores hydrogen in a sufficiently large amount to supply hydrogen to the ammonia synthesis facility 400 that is continuously running even in the nighttime. In the hydrogen tank 240A, a pressure indicator (PI) 232 is fixed, and the pressure indicator 232 detects the pressure in the tank. In FIG. 6, one hydrogen tank 240 is shown, but the hydrogen storage facility 200 may have a plurality of tanks so as to store a necessary amount of hydrogen for the nighttime running according to the amount of ammonia produced in the ammonia synthesis facility 400. The hydrogen stored in the hydrogen tank 240 is charged into a line 201, and the hydrogen in the line 201 is transferred to the nitrogen production facility 300 or the ammonia synthesis facility 400.

The line 203 is a line bypassing the hydrogen tank 240. In the case of supplying a part of the produced hydrogen to the hydrogen tank 240, other hydrogen is supplied to the nitrogen production facility 300 or the ammonia synthesis facility 400 while bypassing the hydrogen tank 240.

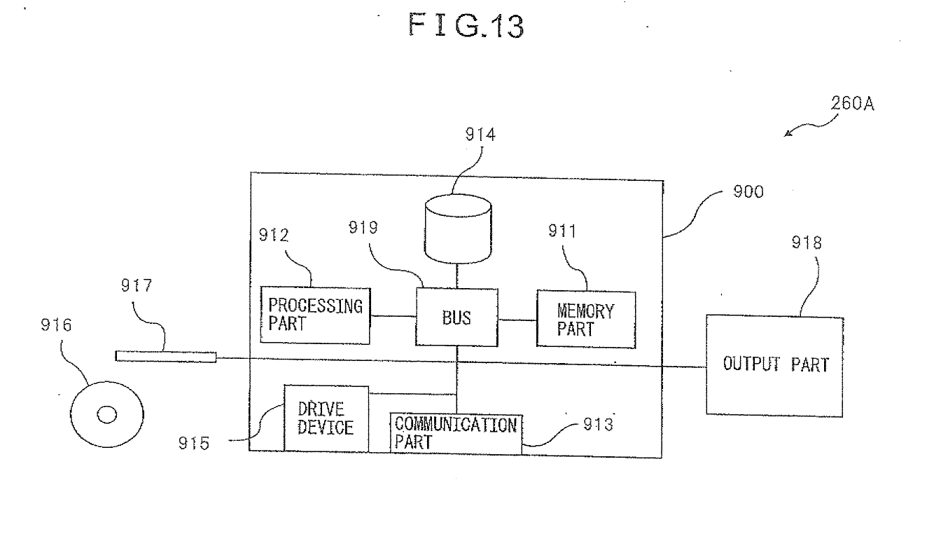

The pressure control apparatus 260A has the same apparatus configuration as a control apparatus described later by referring to FIG. 13. When the pressure in the line 201 is decreased, hydrogen stored in the hydrogen tank 240 is pressurized using the pressure control apparatus 260A, whereby the pressure control apparatus 260A maintains the pressure in the line 201. Incidentally, regarding the pressure in the hydrogen tank 240, when the hydrogen production facility 100 is working, the produced hydrogen is supplied and therefore, the pressure can be maintained, but when the hydrogen production facility 100 is stopped, hydrogen is not supplied and moreover, hydrogen is supplied to the ammonia synthesis facility 400, as a result, the pressure in the hydrogen tank 240 lowers.

To avoid this, the pressure control apparatus 260A monitors the pressure in the line 201 and when the pressure in the line 201 is decreased, actuates and controls the compression unit 250A to maintain the pressure in the line 201. The pressure in the hydrogen tank 240 gradually decreases according to the amount of hydrogen supplied to the nitrogen production facility 300 and the ammonia synthesis facility 400. Therefore, it is preferred that the compression unit 250A can change the compression ratio in response to pressure reduction of the line 201. The compression unit 250A shown in FIG. 6 has a multistage compressor so as to change the compression ratio. For example, when the pressure reduction of the line 201 occurs, a control valve 252 and a control valve 255 are closed, a control valve 251 and a control valve 256 are opened, a compressor 253 is started, and hydrogen pressurized by the compressor 253 is supplied to the line 201. Furthermore, when the pressure is decreased, the control valve 252 and the control valve 256 are closed, the control valve 251 and the control valve 255 are opened, the compressor 253 and a compressor 257 are started, and hydrogen pressurized by the compressor 253 and the compressor 257 is supplied to the line 201. In the compressor 253 and the compressor 257, the rotation speed may be controlled by inverter control according to the pressure. If the discharge pressure of the compressor can be changed by inverter control according to the pressure of line 201, the compression unit 250A may have only one compressor. In this way, the pressure in the line 201 is maintained constant by the compression unit 250A.

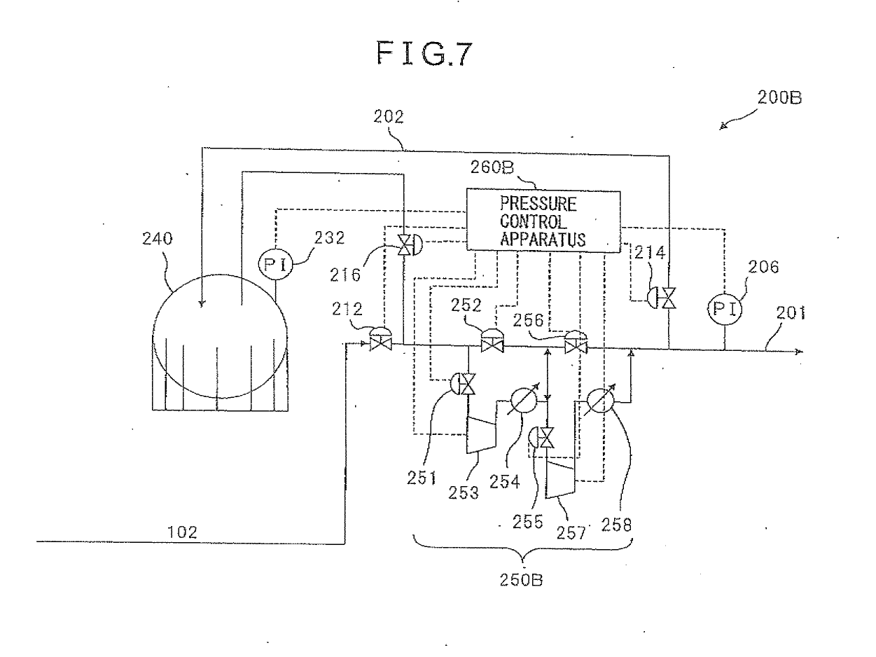

FIG. 7 shows a hydrogen storage facility 200B that is another example of the hydrogen storage facility 200. The hydrogen storage facility 200B has a hydrogen tank 240, a compression unit 250B and a pressure control apparatus 260B.

The difference between the hydrogen storage facility 200B and the hydrogen storage facility 200A is that the compression unit 205B has both a function of pressurizing hydrogen supplied by the line 102 from the hydrogen production facility 100 and a function of pressurizing hydrogen supplied from the hydrogen tank 240 so as to prevent pressure reduction of the line 201 in the nighttime and the compressor 210 shown in FIG. 6 is made unnecessary. The equipment configuration of the compression unit 250B is the same as that of the compression unit 250A shown in FIG. 6.

During operation of the hydrogen production facility 100, the pressure control apparatus 260B opens a control valve 212 and a control valve 214 and closes a control valve 216. The pressure control apparatus 260B further closes a control valve 252 and a control valve 256 while opening a control valve 251 and a control valve 255 and actuates a compressor 253 and a compressor 257. In this way, the compression unit 250B pressurizes and transfers the produced hydrogen from the hydrogen production facility 100 to the hydrogen tank 240, the nitrogen production facility 300 and the ammonia synthesis facility 400. During stopping of the hydrogen production facility 100, the pressure control apparatus 260B opens the control valve 216 while closing the control valve 212 and the control valve 214 and activates the compression unit 250B to pressurize and transfer hydrogen in the hydrogen-tank 240 to the hydrogen tank 240, the nitrogen production facility 300 and the ammonia synthesis facility 400. The running of the compression unit 250B during stopping of the hydrogen production facility 100 is the same as that of the compression unit 250A.

In this way, the compression unit 250B has a function of pressurizing the produced hydrogen supplied from the line 102 and a function of pressurizing hydrogen supplied from the hydrogen tank 240, so that the compressor 210 shown. in FIG. 6 can be made unnecessary.

### <Nitrogen Production Facility (Production Method of Nitrogen)>

The nitrogen production facility 300 is a facility including a function of producing nitrogen working out to a part of a synthesis gas in the ammonia synthesis facility 400, from air and storing a part thereof.

The nitrogen production facility 300 produces nitrogen from air by the following method (C1) or (C2).

### (C1) Cryogenic Separation

In the cryogenic separation method, air is compressed while cooling it to create liquid air, and nitrogen is separated from the liquid air by utilizing the difference in boiling point between oxygen and nitrogen. In the cryogenic separation method, high-purity nitrogen is obtained, but a large-scale facility and a relatively large amount of energy are required.

### (C2) Removal of Oxygen by Combustion

A nitrogen gas can also be produced by burning the produced hydrogen (H₂) in air and consuming oxygen in the air. Incidentally, the combustion reaction of hydrogen is an exothermic reaction and therefore, it is also possible to create electric power and the like required in an ammonia production plant 10 by utilizing the heat of reaction.

### <Nitrogen Production Facility (Facility for Producing Nitrogen by Hydrogen Combustion)>

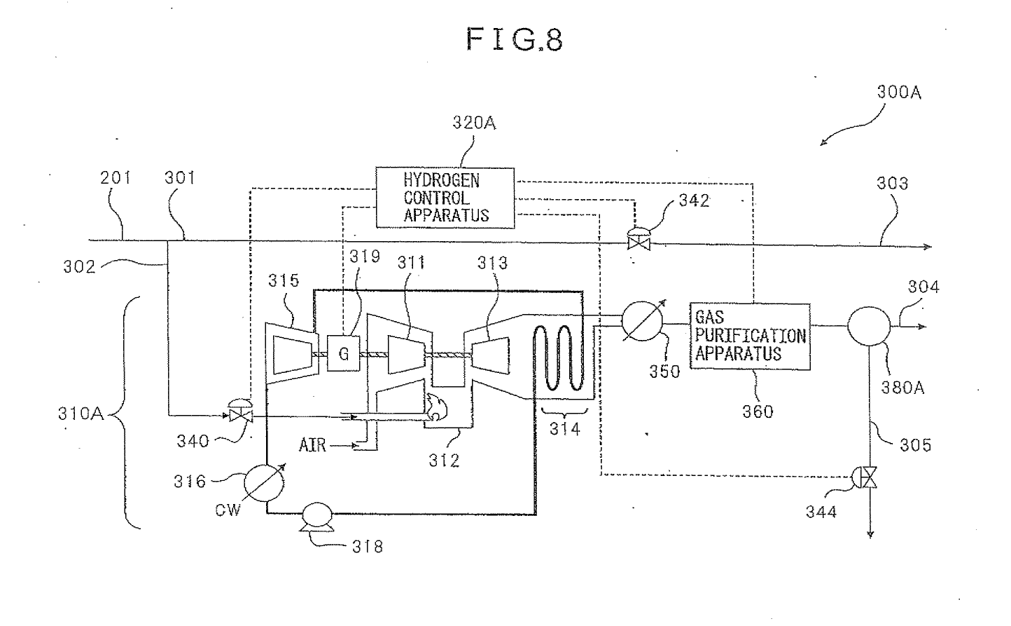

FIG. 8 shows one example of the nitrogen production facility for producing nitrogen by hydrogen combustion. The nitrogen production facility 300A has a hydrogen combustion apparatus 310A, The nitrogen production facility 300A may have a hydrogen control apparatus 320A, a control valve 340, a control valve 342, a heat exchanger 350, a gas purification apparatus 360 and nitrogen storage equipment 380A.

In this way, the nitrogen production facility 300A produces nitrogen by burning the produced hydrogen and air and supplies the electric power generated by the combustion to at least one of the ammonia synthesis facility 400 and, a hydrogen production facility 100.

The hydrogen control apparatus 320A separates the hydrogen supplied from a line 201 by using control valves 340 and 342 into a line 302 for the supply to the hydrogen combustion apparatus 310A and a line 303 connected to the ammonia synthesis facility 400.

The hydrogen combustion apparatus 310A has a air compressor 311, a combustor 312, a gas turbine 313, an exhaust heat recovery boiler 314, a steam turbine 315, a condenser 316, a pump 318 and a power generator 319. The air compressor 311 compresses air to a predetermined pressure according to the pressure conditions of the combustor 312. The combustor 312 burns hydrogen supplied from the line 302 and air compressed by the air compressor 311 to perform a combustion reaction of hydrogen. Incidentally, the nitrogen production facility 300A can obtain hydrogen stored in the hydrogen storage facility 200, so that even during stopping of the hydrogen production facility 100, the hydrogen combustion apparatus 310A can continue its running. Accordingly, an energy loss associated with the startup process and shutdown process of the hydrogen combustion apparatus 310A is not produced.

A chemical formula when the combustion of a hydrogen gas is at a stoichiometric ratio is shown below.

H₂+2.4Air→H₂O+1.88N₂+0.023Ar+0.0007CO₂ (formula 12)

In this way, nitrogen for an ammonia synthesis gas can be produced by the hydrogen combustion apparatus 310A and at the same time, a synthesis gas of hydrogen and nitrogen having a desired stoichiometric ratio can be produced by mixing a hydrogen gas supplied from the line 303 in the downstream ammonia synthesis facility 400.

The combustion limit of hydrogen in air is from 4 to 75 (vol %), and the mixing ratio of hydrogen and nitrogen can be freely varied in the combustion limit range of hydrogen. Accordingly, hydrogen combustion may be performed by raising the mixing ratio of a hydrogen gas to air to 75 vol % that is the upper limit of combustion limit. For example, a hydrogen gas is supplied from the line 303 according to the nitrogen amount and hydrogen amount in the exhaust, gas after combustion, and the mixing ratio in the ammonia synthesis gas is thereby set to hydrogen:nitrogen=3:1. Based on this condition, a hydrogen gas is previously supplied from the line 302 to the hydrogen combustion apparatus 310A such that the ratio of hydrogen:nitrogen in the exhaust gas after combustion becomes 3:1, whereby the additional supply of a hydrogen gas from the line 303 can be made unnecessary. Even in this case, as shown by the following formula 13, the hydrogen concentration in the introduced gas is still 73.4 vol % that is a combustion region of hydrogen.

6.63H₂+2.4Air→H₂O+1.88N₂+5.63H₂+0.023Ar+0.0007CO₂ (formula 13)

On the other hand, although not shown in formulae 12 and 13, nitrogen oxide (NOx) is produced by the hydrogen combustion reaction. In the ammonia synthesis, an oxygen-containing compound is a catalyst poison and therefore, NOx is removed by a gas purification apparatus 360 described later. The concentration of NOx in the combustion gas can be decreased by making the amount of hydrogen based on oxygen larger than the stoichiometric ratio. Therefore, it is preferred to perform the combustion by setting the amount of hydrogen based on oxygen to be larger than the stoichiometric ration according to the capacity of the later-described NOx removal equipment, in other words, perform the combustion of air in excess hydrogen than the constituents in stoichiometric proportions.

Incidentally, the hydrogen control apparatus 320A supplies hydrogen to be burned in the hydrogen combustion apparatus 310A, in a certain hydrogen excess ratio by using control valves 340 and 342 to burn the hydrogen. The hydrogen excess ratio may be determined according to at least any one of an oxygen concentration and a nitrogen oxide concentration in the combustion gas and the power generation efficiency. The oxygen concentration and nitrogen oxide concentration in the combustion gas may be set in the hydrogen control apparatus 320A by using periodically detected data, or the detection values detected in the later-described gas purification apparatus 360 maybe used. Furthermore, the hydrogen control apparatus 320A can obtain the power generation efficiency from the power generation amount of the power generator 319 and the hydrogen flow rate in the line 302.

The combustion temperature in the combustor 312 is, for example, from 1,100 to 1,500° C. Elevation of the power generation efficiency by the gas turbine 313 incurs a rise in the pressure of the combustor 312. For this reason, the compression ratio of air supplied is, for example, from 11 to 23. Accordingly, the supply pressure of the line 302 supplying hydrogen to the combustor 312 becomes larger than from 11 to 23 atm by taking into consideration the pressure loss in piping. The hydrogen combustion apparatus 310A is a combined cycle power-generating apparatus. The gas turbine 313 is a turbine that is rotated by a high-temperature high-pressure combustion gas from the combustor 312. The exhaust heat recovery boiler 314 is a boiler that generates steam by heat-exchanging of a high-temperature exhaust gas from the gas turbine 313 with water. The steam turbine 315 is a turbine that is rotated by the steam generated due to heat-exchanging by the exhaust heat recovery boiler 314. The power generator 319 obtains power from the gas turbine 313 and the steam turbine 315 and generates electric power by a rotating rotor. The condenser 316 cools the steam discharged from the steam turbine and returns it to water, and the water is again fed into the exhaust heat recovery boiler 314 by the pump 318.

As described above, the electric power generated by the power generator 319 together with the production of a nitrogen gas can be used as electric power for at least one of the hydrogen storage facility 200 and the ammonia synthesis facility 400. Also, the heat recovered from the heat exchanger 350 can be used as a heat source for at least one of the hydrogen production facility 100, the hydrogen storage facility 200, the nitrogen production facility 300 and the ammonia synthesis facility 400. Therefore, not only nitrogen is merely produced but also, by utilizing the energy due to hydrogen combustion, the ammonia production plant 10 can continue its running day and night without receiving an electricity from the outside or by reducing the external electric power.

Incidentally, the nitrogen production facility 300A burns the produced hydrogen to obtain a nitrogen amount necessary for ammonia synthesis. The nitrogen production facility 300A burns the produced hydrogen in an amount large enough to obtain electric power determined from the electric power necessary for at least one of the ammonia synthesis facility 400 and the hydrogen production facility 100. As a result, the nitrogen production facility 300A can supply nitrogen that is a raw material of an ammonia synthesis gas. This enables the ammonia production plant 10 to continue its running day and night without receiving an electricity from the outside or by reducing the external electric power. In case of high electric power demand, the amount of nitrogen produced sometimes exceeds the nitrogen amount necessary fox ammonia synthesis. In such a case, nitrogen is stored using the nitrogen storage equipment 380A as a buffer and furthermore, the excess nitrogen is supplied to the outside for the purpose of utilizing it other than in the ammonia production plant 10, through the line 305 by letting the hydrogen control apparatus 320A control the control valve 344. In this way, nitrogen storage equipment 380A is provided and nitrogen produced in excess is stored therein, so that a latitude of decreasing the power generation amount of the hydrogen combustion apparatus 310A, i.e., the amount of nitrogen produced, can be created, For example, when the electric power demand in the ammonia production plant 10 is fluctuated or the demand for generated output by the hydrogen combustion apparatus 310A is temporarily decreased, a buffer can be produced by nitrogen storage, and smooth action as a plant can be achieved. Also, a more efficient or more inexpensive electric power supply facility, such as solar thermal power generation or nighttime electric power, can be used. Furthermore, when a more excess nitrogen gas is supplied to the outside from the line 305, the nitrogen production facility 300 not only has a function of producing an ammonia synthesis gas but also can function as an apparatus for merely producing nitrogen.

The exhaust gas from the heat exchanger 350 is supplied to the line 304. The hydrogen control apparatus 320A an apparatus for controlling the hydrogen supply amount to the line 303 and the hydrogen supply amount to the line 302. The hydrogen control apparatus 320A controls the amount of hydrogen supplied to the combustor 312 by using the control valve 340. The hydrogen control apparatus 320A controls the hydrogen amount to the line 302, whereby the mixing ratio of hydrogen to nitrogen in the hydrogen combustion can be controlled.

In the ammonia synthesis, an oxygen-containing compound is a catalyst poison and therefore, CO₂ contained in air, water produced by hydrogen combustion, and NOx must be removed to predetermined concentrations. Accordingly, the gas purification apparatus 360 is used for removing by-products except for hydrogen and nitrogen, produced by the hydrogen gas combustion reaction, according to the inlet conditions of the ammonia synthesis facility 400.

The gas purification apparatus 360 may contain water (H₂O) removal, carbon dioxide (CO₂) removal, oxygen (O₂) removal, NOₓ removal and hydrogen peroxide (H₂O₂) removal equipment. The water removal equipment includes a drier filled with zeolite. The carbon dioxide (CO₂) removal equipment includes a method of performing reaction and absorption by using an aqueous potassium carbonate solution (following formulae).

K₂CO₃+CO₂→2KHCO₃(absorption reaction at low temperature) (formula 14)

K₂CO₃+CO₂→2KHCO₃(regeneration reaction at high temperature) (formula 15)

The oxygen (O₂) removal equipment includes a catalyst reaction with H₂ in the presence of Pd or Pt, a separation membrane, and a PSA (Pressure Swing Adsorption) method. The NOx removal equipment includes a removal method using ammonia.

The gas purification apparatus 360 may continuously detect the oxygen concentration and nitrogen oxide concentration in the combustion gas and notify the hydrogen control apparatus 320A of the detection values,

### <Nitrogen Production Facility (Facility for Producing Nitrogen by Cryogenic Separation)>

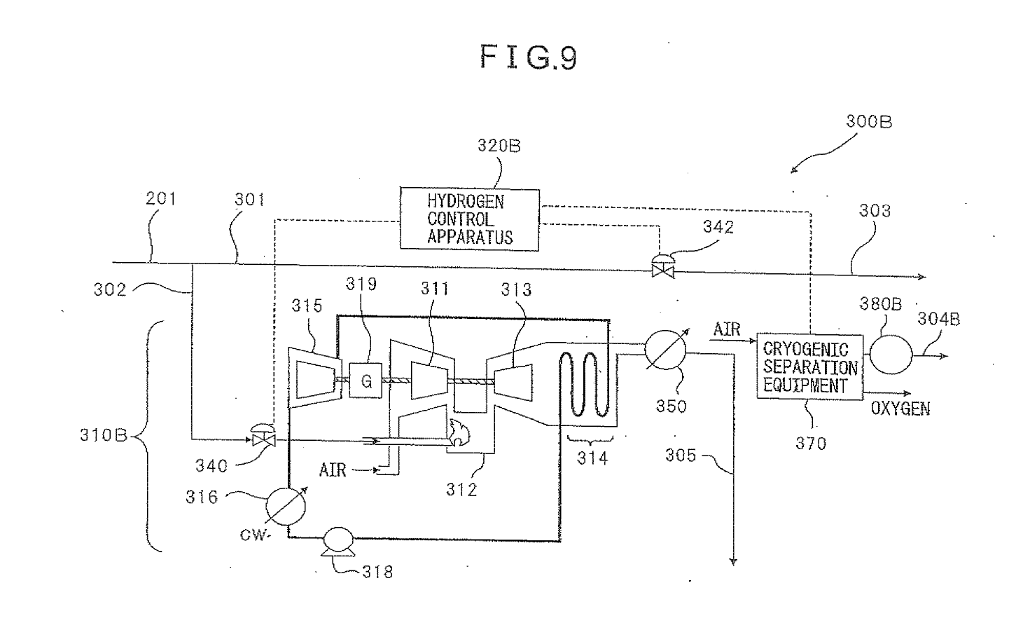

FIG. 9 shows one example of the nitrogen production facility for producing nitrogen by cryogenic separation. The nitrogen production facility 300B differs froₘ the nitrogen production facility 300A in further having cryogenic separation equipment 370 and not having a gas purification apparatus 360, but other apparatuses are common with the nitrogen production facility 300A. The hydrogen combustion apparatus 310B is provided as power generation equipment but not for nitrogen production, and the electric power generated in the hydrogen combustion apparatus 310B is supplied to at least one of the cryogenic separation equipment 370, the hydrogen storage facility 200 and the ammonia synthesis facility 400. Incidentally, the nitrogen production facility 300B burns the produced hydrogen in an amount large enough to obtain electric power determined from the electric power necessary for at least one of the cryogenic separation equipment 370, the ammonia synthesis facility 400 and the hydrogen production facility 100. The hydrogen control apparatus 320B can control the amount of nitrogen that is produced in the cryogenic separation equipment 370 and supplied to the line 304 according to the amount of hydrogen supplied to the line 303.

The nitrogen production facility 300B can obtain hydrogen stored in the hydrogen storage facility 200, so that even during stopping of the hydrogen production facility 100, the hydrogen combustion apparatus 310B _{can} continue its running.

Accordingly, the nitrogen production facility 300B has power generation equipment for supplying electric power generated by burning the produced hydrogen and air to at least one of the cryogenic separation equipment 370, the ammonia synthesis facility 400 and the hydrogen storage facility 200, makes it unnecessary to receive electricity from the outside, and enables the ammonia production plant 10 and the cryogenic separation equipment 370 to continue running. Accordingly, energy loss associated with the startup process and shutdown process of the cryogenic separation equipment 370 can be reduced. The nitrogen production facility 300B may have nitrogen storage equipment 380B. By virtue of having nitrogen storage equipment, nitrogen can be stored by producing it with use of other more efficient or more inexpensive electric power. For example, in the case where the ammonia production plant 10 has the power generation unit 190 shown in FIG. 5, nitrogen can be produced in the cryogenic separation equipment 370 by utilizing electric power generated using daytime excess solar heat and can be stored in the nitrogen storage equipment 380B. Also, when electric power can be supplied from the outside, it is possible to produce extra nitrogen by using midnight electric power and store the nitrogen.

Description of other apparatuses in the nitrogen production facility 300B, which are common with the nitrogen production facility 300A, is omitted here.

As for the nitrogen produced by cryogenic separation, the air introduced is deprived of water and carbon dioxide before entering a cold box in the cryogenic separation equipment, and the air is liquefied and then separated into oxygen and nitrogen. The oxygen-containing compound in the nitrogen gas produced here is in an extremely low concentration and therefore, the gas purification apparatus 360 can be dispensed with. Also, the by-produced oxygen can be utilized outside of the ammonia production plant 10.

### <Ammonia Synthesis Facility (Ammonia Synthesis Method)>

This is a facility for synthesizing ammonia from hydrogen and nitrogen.

The ammonia synthesis is represented by the following reaction formula and is an exothermic reaction.

N₂+3H₂→2NH₃(about 400° C.) (formula 16)

As shown in formula 16, the synthesis is a reaction involving decrease of the volume and therefore, the reaction pressure is preferably a high pressure in view of chemical equilibrium. Although the ammonia synthesis reaction is an exothermic reaction, power is required in the ammonia synthesis because of need for a compression process.

### <Ammonia Synthesis Facility (Description of Facility)>

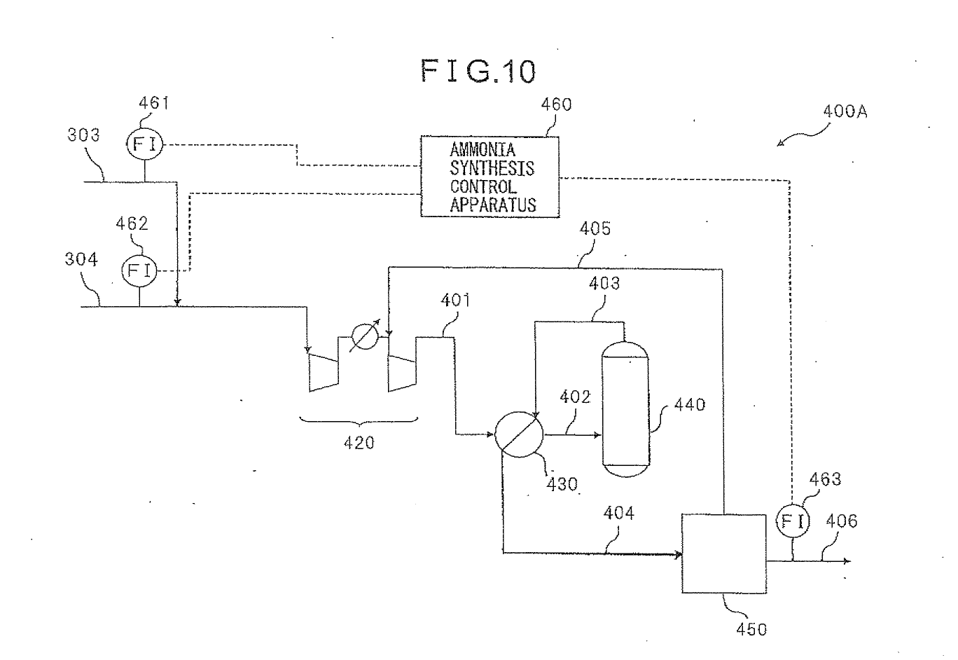

FIG. 10 shows, one example of the ammonia synthesis facility. The ammonia synthesis facility 400A has a synthesis gas compressor 420, a synthesis gas heat exchanger 430, a reaction vessel 440, liquefaction equipment 450 and an ammonia synthesis control apparatus 460. In the line 303, a flow indicator (FI) 461 for detecting the flow rate of hydrogen flowing in the line 303 is provided. In the line 304, a flow indicator 462 for detecting the flow rate of nitrogen flowing in the line 304 is provided. In a line 406, a flow indicator 463 for detecting the flow rate of ammonia flowing in the line 406 is provided. The ammonia synthesis control apparatus 460 controls each equipment based on the hydrogen flow rate obtained from the flow indicator 461 and the nitrogen flow rate obtained from the flow indicator 462 so that a predetermined ammonia production amount working out to a set value based on the stoichiometric ratio represented by formula 16 can be obtained from the flow indicator 463. Incidentally, in the ammonia synthesis control apparatus 460, the predetermined ammonia production amount working out to a set value may be received from a control apparatus 900 described later.

The synthesis gases supplied from lines 303 and 304 are raised in pressure by the gas compressor 420 to a reaction pressure of the reaction vessel 440. The synthesis gas is then discharged from the synthesis gas compressor 420 and supplied to the line 401. The synthesis gas in the line 401 is supplied to the low-temperature side of the synthesis gas heat exchanger 430.

The synthesis gas compressor 420 is a compressor for pressurizing a synthesis gas containing hydrogen and nitrogen to a reaction pressure for the ammonia synthesis reaction. The synthesis gas compressor is a multistage centrifugal compressor or a multistage axial flow compressor. In FIG. 10, the synthesis gas compressor 420 is composed of two compressors, but the present invention is not limited to this construction.

The synthesis gas heat exchanger 430 is a heat exchanger where an ammonia gas elevated in temperature due to exothermic reaction of the synthesis gas is put in a high temperature side and the synthesis gas is put in the low temperature side. In this way, by utilizing a temperature-elevated ammonia gas as a heat medium, it becomes unnecessary to externally supply an energy for heating the synthesis gas to a reaction temperature.

The reaction vessel 440 is a device where a predetermined catalyst is filled and an ammonia synthesis reaction represented by formula (16) is performed.

The ammonia synthesized in the reaction vessel 440 is supplied to the line 403. The ammonia supplied to the line 403 is lowered in the temperature by the synthesis gas heat exchanger 430 and supplied to the line 404. The line 404 is connected to the liquefaction equipment 450.

In the liquefaction facility 450, the produced ammonia is liquefied and taken out into the line 406, and the unreacted synthesis gas is returned to the line 405, pressurized together with a new synthesis gas by the synthesis gas compressor 420 and charged into the reaction vessel 440. The ammonia liquefied in the liquefaction equipment 450 is stored in ammonia storage equipment (not shown) from the line 406 and shipped by land and/or by sea.

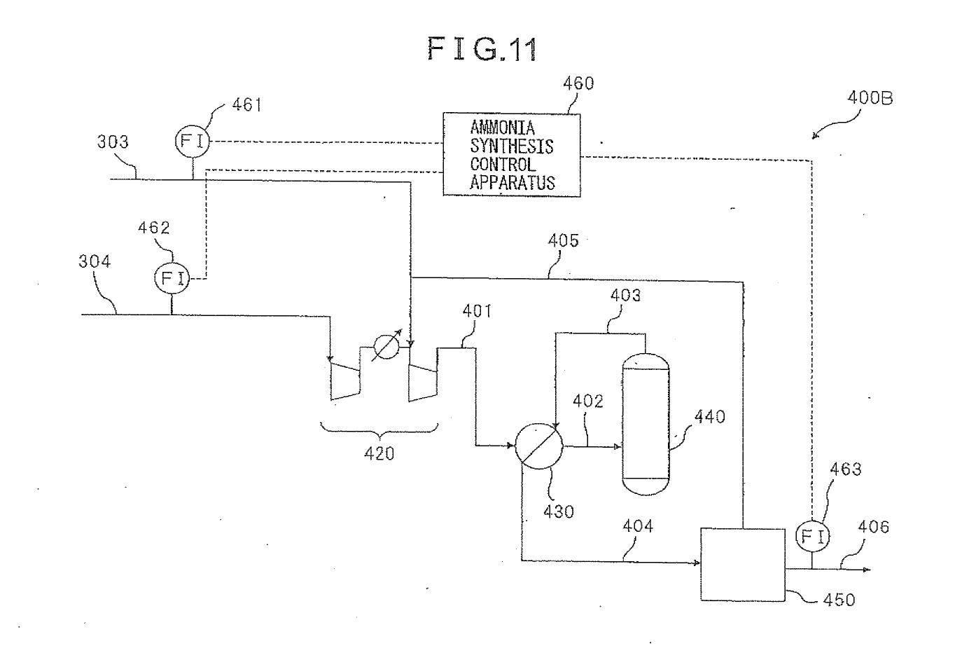

FIG. 11 shows another example of the ammonia synthesis facility. The ammonia synthesis facility 400B has the same configuration as the ammonia synthesis facility 400A described by referring to FIG. 10 except that the line 303 is connected to the later stage side of the synthesis gas compressor 420. Accordingly, description of the same constitutions as in the ammonia synthesis equipment 400A is omitted.

Nitrogen supplied to the line 304 is supplied to the inlet of a first-stage compressor of the synthesis gas compressor 420. Hydrogen supplied to the line 303 is supplied to the inlet of a second-stage compressor of the synthesis gas compressor 420.

The pressure of nitrogen supplied from the line 304 is a discharge pressure of the gas turbine 313 and in turn, is a low pressure. Hydrogen supplied from the line 303 is supplied from the hydrogen tank 202 in which the hydrogen is compression stored, and therefore, the pressure thereof is a high pressure. Accordingly, nitrogen from the line 304 may be supplied to a first stage of the compressor, and hydrogen from the line 303 may be supplied to a second or subsequent stage of the compressor. Incidentally, in FIG. 11, a synthesis gas compressor 420 having a multistage configuration is illustrated by way of example, but the synthesis gas compressor is not limited to the synthesis gas compressor 420 described by referring to FIG. 11.

In this way, hydrogen with a number of mols as large as three times that of nitrogen supplied from the line 304 is charged from the line 303 into the inlet side of a later stage of the compressor, whereby the power required of the synthesis gas compressor 420 can be greatly reduced as compared with the case of charging hydrogen into a first stage and pressurizing it. As described above, in an ammonia production plant, the power for synthesis gas compression occupies a large proportion in the required energy per ammonia and therefore, when the power required of the synthesis gas compressor 420 is decreased, the required energy per ammonia can be reduced.

### <Control of Ammonia Synthesis Facility>

The hydrogen production facility 100 varies in the hydrogen production amount depending on the insolation value and therefore, in the ammonia production plant 10, the ammonia production amount may be controlled according to the insolation value.

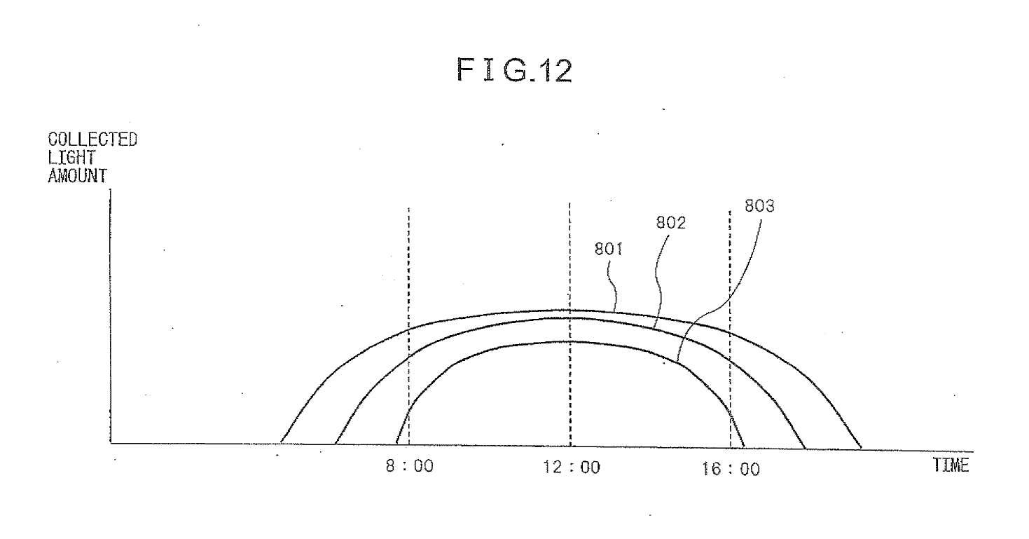

FIG. 12 is a view illustrating one example of the collected light amount of insolation. The collected light amount curve 801 indicates the collected light amount in summer. The collected light amount curve 803 indicates the collected light amount in winter. The collected light amount curve 802 indicates the collected light amount in spring or autumn. As shown in the Figures, the collected amount of light is large in summer because of the long time between sunrise and sunset. On the other hand, the collected light amount is small in winter because of a short time between sunrise and sunset. In the case where the collected light amount is small, sufficient hydrogen for the target ammonia production amount is sometimes not obtained. Also, when the amount of collected light is large, excess hydrogen is produced. Accordingly, the ammonia production plant 10 preferably controls the ammonia production amount according to the collected light amount.

One example of the control apparatus for performing computation of the ammonia production amount and control of the ammonia production amount is described by referring to FIG. 13. The control apparatus 900 has a memory part 911, a processing part 912, a communication part 913, an outer memory device 914, a drive device 915 and a bus 919. Although not shown, the control apparatus 900 is connected, through the communication part 913, to instrumentation devices of the ammonia production plant 10, the pressure control apparatus 260A or pressure control apparatus 260B, the hydrogen control apparatus 320A or hydrogen control apparatus 320B, and the ammonia synthesis control apparatus 460.

The control apparatus 900 stores insolation value information, hydrogen tank residual amount and weather forecast information in the memory part 911. The insolation value information and the weather forecast information can be received on the network through the communication part 913 from an external system in which the insolation value and the weather are forecasted. The control apparatus 900 acquire the hydrogen tank residual amount by using the pressure information acquired from the pressure indicator 232 of the hydrogen tank. The insolation value information is information for recording the insolation value per hour determined according to the time between sunrise and sunset, which varies seasonally, and the weather forecasting and forecasting the light collected amount and hydrogen production amount by using the record. In other words, the isolation information is information containing the isolation, where, for example, as shown in FIG. 12, the fluctuation of season or time is recorded.

The control apparatus 900 further stores a program for computing the ammonia production amount and allowing the ammonia synthesis facility to produce ammonia in the computed ammonia production amount. The processing part 912 of the control apparatus 900 realizes an ammonia production amount computing function by executing the program above. The control apparatus 900 sends the ammonia production amount computed by the ammonia production amount computing function, as a set value to the ammonia synthesis control apparatus 460, whereby the ammonia production amount of the ammonia synthesis facility 400 can be controlled.

In this way, the control apparatus 900 computes the hydrogen amount producible in one day based on the solar insolation value information, at the same time, computes the production amount of ammonia starting from hydrogen in the computed production amount, and thereby allows the ammonia synthesis facility 400 to produce ammonia in the computed ammonia production amount.

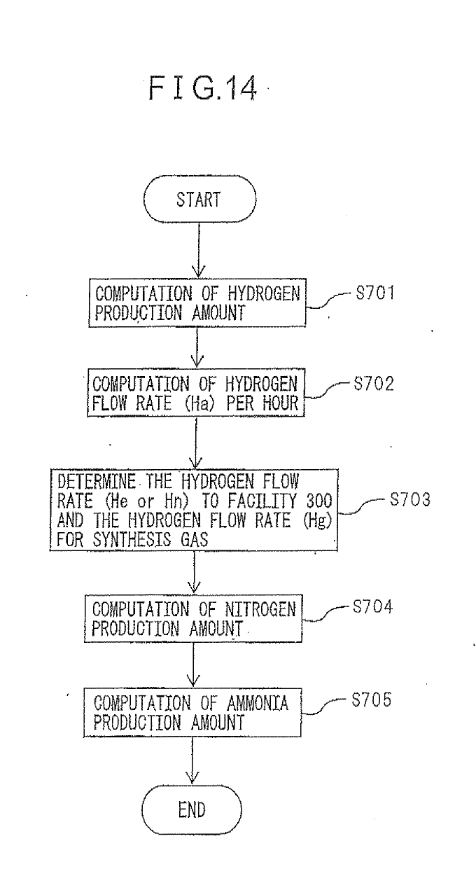

One example of the flow of processing to perform computation of the ammonia production amount and control of the ammonia production amount by the control apparatus 900 is described by referring to FIGS. 13 and 14.

The processing part 912 of the control apparatus 900 computes the hydrogen production amount by using the insolation value obtained from the insolation value information (S701). The hydrogen production amount is computed based on the thermal energy obtained from the insolation value. In the processing part 912, the hydrogen flow rate per hour supplied from the hydrogen storage facility 200 to the nitrogen production facility 300 and the ammonia synthesis facility 400 is computed , from the computed hydrogen production amount (S702). Next, the processing part 912 determines the hydrogen flow rate to the nitrogen production facility 300 and the ammonia synthesis facility 400 (S703). The hydrogen combustion reaction is performed for nitrogen production and power generation, but the hydrogen flow rate is determined based on a dominant amount out of the nitrogen production amount and the power generation. In the case where, for example, the power generation efficiency of the hydrogen combustion apparatus 310 is high and the power consumption effect of the ammonia synthesis facility 400 is large, the predetermined power generation amount is satisfied with a small hydrogen amount, while when a sufficiently large nitrogen amount for the synthesis gas is not obtained, the hydrogen flow rate to the nitrogen production facility 300 is determined to produce nitrogen. Furthermore, An the case where the electric power demand is large, the hydrogen flow rate to the nitrogen production facility 300 is determined to produce nitrogen more than the nitrogen amount necessary for the synthesis gas and perform power generation.

Incidentally, the hydrogen flow rate can be calculated using the following formulae:
Ha: the hydrogen supply amount to the nitrogen production facility 300 and the ammonia synthesis facility,
Hg: the hydrogen flow rate of the synthesis gas,
He: the hydrogen flow rate for power generation,
Hn: the hydrogen flow rate for nitrogen production,
Ng: the nitrogen flow rate in the synthesis gas,
a: a predetermined constant (a constant determined from the required electric power of ammonia production)
b: the ratio of hydrogen necessary for nitrogen production to nitrogen,

Ha=Hg+He (formula 21)

Ha=Hg+Hn (formula 22)

He=axHg (formula 23)

Hn=bxNg (formula 24)

Ng=1/3×Hg (formula 25)

In the case of determining the hydrogen flow rate for the purpose of power generation, the hydrogen flow rate (Hg) of the synthesis gas is determined by the following formula 26 obtained using formulae 21 and 23:

Hg=Ha/(1+a) (formula 26)

In the case of determining the hydrogen flow rate for the purpose of nitrogen production, the hydrogen flow rate (Hg) of the synthesis gas is determined by the following formula 27 obtained using formulae 22, 24 and 25:

Hg=Ha/(1+b/3) (formula 27)

The processing part 912 determines Ng from the computed Hg (S704) and further computes the ammonia production amount from Hg and Ng (S705). The control apparatus 900 sends the thus-computed ammonia production amount as a set value to the ammonia synthesis control apparatus 460, whereby the ammonia production amount of the ammonia synthesis facility 400 can be controlled.

The hydrogen production amount and ammonia production amount are computed and controlled based on the insolation value information, and the hydrogen amount sent to the ammonia synthesis facility 400 is computed by equalizing hydrogen that is produced only under insolation, whereby the energy loss due to intermittent running can be avoided and in turn, ammonia can be produced by efficiently utilizing the solar energy.

### <Combined Plant for Supplying Ammonia Synthesis Gas>

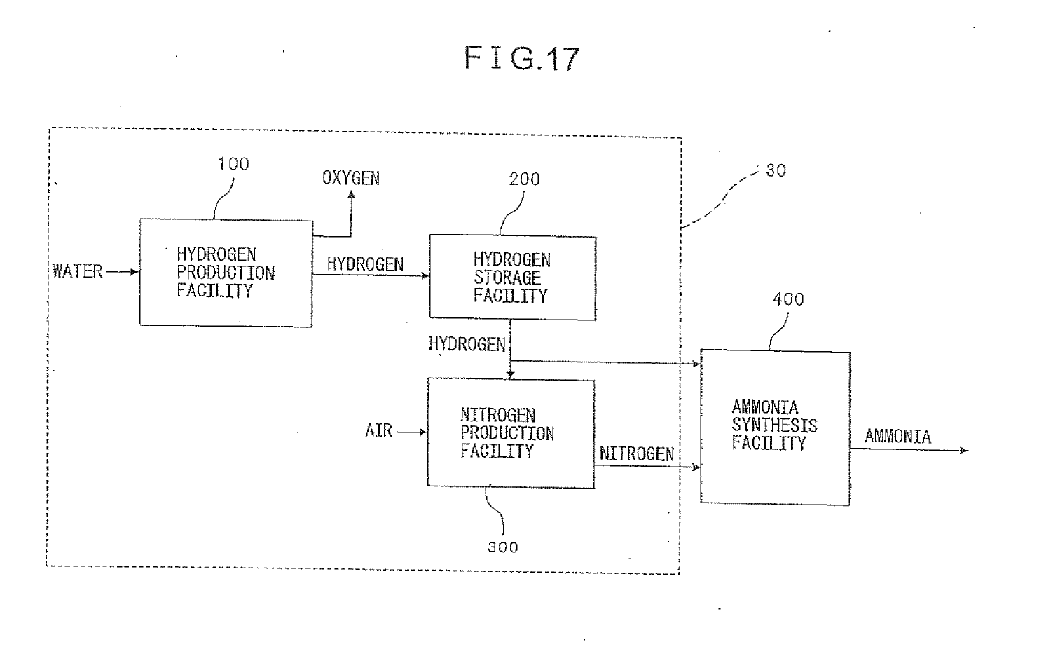

FIG. 17 shows one example of the combined plant for supplying a synthesis gas to an ammonia synthesis facility 400. The combined plant 30 is a plant for supplying a synthesis gas to the ammonia synthesis facility 400.

The combined plant 30 has the hydrogen production facility 100A, the hydrogen storage facility 200A or hydrogen storage facility 200B, and the nitrogen production facility 300A or nitrogen production facility 300B, which are described by referring to FIGS. 5 to 9, and supplies a synthesis gas containing hydrogen and nitrogen to the ammonia synthesis facility 400. The hydrogen production facility 100A, the hydrogen storage facility 200A or hydrogen storage facility 200B, and the nitrogen production facility 300A or nitrogen production facility 300B are already described, and therefore a description is omitted.

In the case where the combined plant 30 has the hydrogen storage facility 200B, by the multifunctionality of the compression unit 250B, the compressor 210 shown in FIG. 6 can be omitted. Also, as described by referring to FIGS. 6 and 7, pressure of the hydrogen stored in the hydrogen tank 240 is raised in accordance with the running pressure of the combustor 312, so that the required volume of the hydrogen tank 240 can be reduced. Furthermore, as described by referring to FIG. 11, hydrogen is supplied to the later stage of the synthesis gas compressor 420, so that the compression power of the synthesis gas compressor 420 in the ammonia gas facility 400 can be lowered.

### <Material Balance of Ammonia Plant>

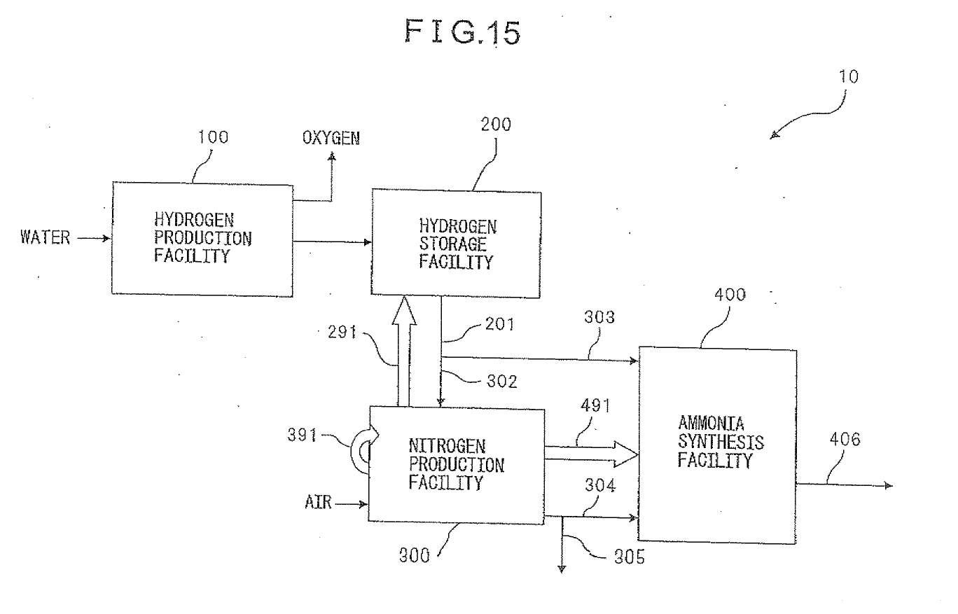

The process flowchart for illustrating the material balance of the ammonia plant is described by referring to FIG. 15.

Lines 201, 303, 304, 305 and 406 are as described in FIGS. 5 to 10. The electric power 291 is an electric power that is supplied to the hydrogen storage facility 200 from the nitrogen production facility 300. The electric power 391 is an electric power that is consumed by cryogenic separation in the nitrogen production facility 300. The electric power 491 is an electric power that is supplied to the ammonia synthesis facility 400 from the nitrogen production facility 300.

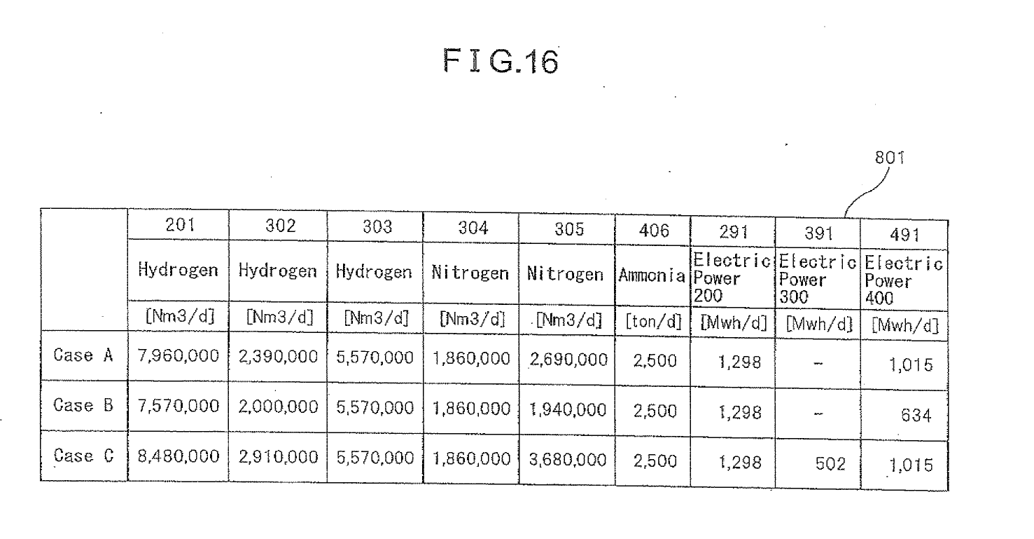

One example of the material balance in the ammonia plant shown in FIG. 15 is described by referring to FIG. 16.

The material balance is calculated for the following three cases.

### Case A)

Nitrogen is produced by hydrogen combustion, and the electricity generated by the hydrogen combustion is used in the nitrogen production facility and the ammonia synthesis facility for 24 hours.

### Case B)

Nitrogen is produced by hydrogen combustion, and the electricity generated by the hydrogen combustion is used in the nitrogen production facility and the ammonia synthesis facility only during nighttime. In the daytime, power is generated by the power generation unit 190 of FIG. 5, and electric power necessary in the nitrogen production facility and the ammonia synthesis facility is supplied from the power generation unit 190.

### Case C)

Nitrogen is produced by cryogenic separation, and the electricity generated by hydrogen combustion is used in the nitrogen production facility and the ammonia synthesis facility only during nighttime.

The calculation conditions for calculating the material balance are as follows.
Ammonia production amount: 2,500 t/d
Nitrogen amount in synthesis gas: 1,860,000 Nm³/d
Hydrogen amount in synthesis gas: 5,570,000 Nm³/d
Power generation efficiency of hydrogen combustion gas: 0.3

FIG. 16 shows Table 801 of material balances obtained for the above-described Cases with the calculation conditions above. As apparent from Table 801, when the ammonia production amount is constant, the required hydrogen flow rate shown in Line 201 decreases in order of Case C, Case A and Case B. Comparison between Case B and Case C where the required electric power during nighttime is completely supplied by the nitrogen production facility 300 reveals that the required hydrogen amount is smaller when the nitrogen is produced by hydrogen combustion than produced by cryogenic separation.

These results are calculated based on several assumptions, and selections in an actual plant are determined, other than this calculation, by taking into consideration a large number of factors such as construction cost and maintenance of plant, availability of external electric power supply, and site area.

All of the examples and conditions disclosed in this specification are described with the intention of enabling the reader to understand the present invention and should not be construed as limiting the present invention. Although working examples of the present invention are described in detail, it should be understood that various modifications, equivalents and alternatives can be made therein without departing from the scope of the invention.

1. A method of producing ammonia, comprising:
acquiring, by a hydrogen production facility, solar energy and producing, by the hydrogen production facility, hydrogen by utilizing a part of the acquired solar energy;
producing, by a nitrogen production facility, nitrogen from air;
storing the hydrogen produced by the hydrogen production facility in a hydrogen storage facility; and
continuously synthesizing, by an ammonia synthesis facility, ammonia from the produced hydrogen and the produced nitrogen.

2. The method as claimed in claim 1, wherein the nitrogen produced by the nitrogen production facility is stored in the nitrogen storage facility.

3. The method as claimed in claim 1, comprising converting thermal energy generated by burning the produced hydrogen and air into electric energy, and supplying the obtained electric power to at least one of the nitrogen production facility, the ammonia synthesis facility and the hydrogen production facility.

4. The method as claimed in claim 1, comprising producing nitrogen by burning the produced hydrogen and air by the nitrogen production facility, converting the thermal energy generated by the combustion into electric energy, and supplying the produced electric power to at least one of the ammonia synthesis facility and the hydrogen production facility.

5. The method as claimed in claim 4, comprising burning, by the nitrogen production facility, air and hydrogen in excess hydrogen than the stoichiometric ratio, and determining the ratio of the excess hydrogen based on at least one of the oxygen concentration in the combustion gas, the nitrogen oxide concentration, and the power generation efficiency.

6. The method as claimed in claim 4, comprising, burning, by the nitrogen production facility, the produced hydrogen in an amount large enough to obtain a nitrogen amount necessary for ammonia synthesis.

7. The method as claimed in claim 3, comprising, burning, by the nitrogen production facility, the produced hydrogen in an amount large enough to obtain electric power determined from the electric power necessary for at least one of the ammonia synthesis facility and the hydrogen production facility.

8. The method as claimed in claim 6, comprising, obtaining, by the nitrogen production facility, the produced hydrogen from the hydrogen storage facility.

9. The method as claimed in claim 3, comprising, storing the hydrogen at a pressure based on the combustion pressure of hydrogen and air in the nitrogen production facility and/or the reaction pressure of the ammonia synthesis in the hydrogen storage facility.

10. The method as claimed in claim 1, comprising computing a hydrogen amount producible in one day based on the solar insolation value information and computing the ammonia production amount based on the computed hydrogen production amount, wherein
in the continuous synthesis of ammonia, ammonia is produced in the computed ammonia production amount.

11. A method of producing an ammonia synthesis gas, comprising:
acquiring, by a production facility, solar energy and producing hydrogen by utilizing a part of the acquired solar energy;
producing, by a nitrogen production facility, nitrogen from air;
storing the hydrogen produced by the hydrogen production facility in a hydrogen storage facility; and
supplying the produced hydrogen and the produced nitrogen to an ammonia synthesis facility.

12. The method as claimed in claim 11, comprising storing the nitrogen produced by the nitrogen production facility in the nitrogen storage facility.

13. The method as claimed in claim 11, comprising producing nitrogen by burning the produced hydrogen and air in the nitrogen production facility, converting the thermal energy generated by the combustion into electric energy, and supplying the obtained electric power to at least one of the ammonia synthesis facility and the, hydrogen production facility.

14. The method as claimed in claim 13, comprising, in the hydrogen storage facility, storing the hydrogen at a pressure based on the combustion pressure of hydrogen and air in the nitrogen production facility and/or the reaction pressure of the ammonia synthesis.

15. An ammonia production plant for producing ammonia by using solar energy, comprising:
a hydrogen production facility for acquiring solar energy and producing hydrogen by utilizing a part of the acquired solar energy,
a nitrogen production facility for producing nitrogen from air,
a hydrogen storage facility for storing the hydrogen produced by the hydrogen production facility; and
an ammonia synthesis facility for continuously synthesizing ammonia from the produced hydrogen and the produced nitrogen.

16. The ammonia production plant as claimed in claim 15, comprising a nitrogen storage facility for storing the nitrogen produced by the nitrogen production facility.

17. The ammonia production plant as claimed in claim 15, comprising power generation equipment for converting the thermal energy generated by burning the produced hydrogen and air into electric energy, and supplying the obtained electric power to at least one of the nitrogen production facility, the ammonia synthesis facility and the hydrogen production facility.

18. The ammonia production plant as claimed in claim 15, wherein the nitrogen production facility produces nitrogen by burning the produced hydrogen and air, converts the thermal energy generated by the combustion into electric energy, and supplies the obtained electric power to at least one of the ammonia synthesis facility and the hydrogen production facility.

19. The ammonia production plant as claimed in claim 18, wherein the nitrogen production facility burns air and hydrogen in excess hydrogen than the stoichiometric ratio, and the ratio of the excess hydrogen is determined based on at least one of the oxygen concentration in the combustion gas, the nitrogen oxide concentration, and the power generation efficiency.

20. The ammonia production plant as claimed in claim 18, wherein in the nitrogen production facility, the produced hydrogen is burnt in an amount large enough to obtain a nitrogen amount necessary for ammonia synthesis.

21. The ammonia production plant as claimed in claim 17, wherein the nitrogen production facility burns the produced hydrogen in an amount large enough to obtain electric power determined from the electric power necessary for at least one of the ammonia synthesis facility and the hydrogen production facility.

22. The ammonia production plant as claimed in claim 20, wherein the nitrogen production facility obtains the produced hydrogen from the hydrogen storage facility.

23. The ammonia production plant as claimed in claim 17, wherein the hydrogen storage facility stores the hydrogen at a pressure based on the combustion pressure of hydrogen and air in the nitrogen production facility and/or the reaction pressure of the ammonia synthesis.

24. The ammonia production plant as claimed in claim 15, comprising a control apparatus for computing a hydrogen amount producible in one day based on the solar insolation value information, computing the ammonia production amount based on the computed hydrogen production amount, and allowing the ammonia synthesis facility to produce ammonia in the computed ammonia production amount.

25. A combined plant of continuously supplying hydrogen and nitrogen to an ammonia synthesis facility that continuously synthesizes ammonia from hydrogen and nitrogen, the combined plant comprising:
a hydrogen production facility for acquiring solar energy and producing hydrogen by utilizing a part of the acquired solar energy;
a nitrogen production facility for producing nitrogen from air and supplying the nitrogen to the ammonia synthesis facility; and
a hydrogen storage facility for storing the hydrogen produced by the hydrogen production facility and supplying the produced hydrogen to the ammonia synthesis facility.

26. The combined plant as claimed in claim 25, comprising a nitrogen storage facility for storing the nitrogen produced by the nitrogen production facility.

27. The combined plant as claimed in claim 25, wherein the nitrogen production facility produces nitrogen by burning the produced hydrogen and air, converts the thermal energy generated by the combustion into electric energy, and supplies the obtained electric power to at least one of the ammonia synthesis facility and the hydrogen production facility.

28. The combined plant as claimed in claim 25, wherein the hydrogen storage facility stores the hydrogen at a pressure based on the combustion pressure of hydrogen and air in the nitrogen production facility and/or the reaction pressure of the ammonia synthesis.
